(19) United States
(12) Patent Application Publication
(10) Pub. No.: US 2025/0075071 A1
(43) Pub. Date: Mar. 6, 2025

(54) MOLDED PRODUCT MANUFACTURED FROM THERMOPLASTIC RESIN COMPOSITION

(71) Applicants: Hyundai Motor Company, Seoul (KR); Kia Corporation, Seoul (KR); LOTTE CHEMICAL CORPORATION, Seoul (KR)

(72) Inventors: Min Jin Choi, Bucheon (KR); Seung Hwan Lee, Seoul (KR); Woo Chul Jung, Bucheon (KR); Kyoung Sil Lee, Seoul (KR); Choon Ho Lee, Hwaseong (KR); In Chol Kim, Uiwang (KR); Young Seung Kim, Uiwang (KR); Yun Seok Bae, Uiwang (KR); Hee Kyoung Ryoo, Uiwang (KR)

(21) Appl. No.: 18/611,452

(22) Filed: Mar. 20, 2024

(30) Foreign Application Priority Data
Aug. 28, 2023 (KR) 10-2023-0112994

(51) Int. Cl. C08L 69/00; B29B 9/12; B29B 9/16; B29C 45/00; B29C 48/00; B29C 48/03; B29C 48/16; B29K 69/00; B29K 269/00; B60R 9/04; C08J 3/20

(52) U.S. Cl. CPC C08L 69/00; B29B 9/12; B29C 45/0001; B29C 48/022; B29C 48/03; B29C 48/16; B60R 9/04; C08J 3/203; B29B 2009/168; B29K 2069/00; B29K 2269/00; B29K 2995/0026; B29K 2995/0087; B29K 2995/0089; C08J 2369/00; C08L 2201/08; C08L 2201/10; C08L 2205/03

(57) ABSTRACT

Provided is a molded product manufactured from a thermoplastic resin composition containing a polycarbonate-based polymer, a polysiloxane-polycarbonate copolymer, a polysiloxane-polyester copolymer, and a benzotriazole-based UV stabilizer having a molecular weight equal to or greater than about 1,800.

### CROSS-REFERENCE TO RELATED APPLICATION

This application claims under 35 U.S.C. § 119(a) the benefit of Korean Patent Application No. 10-2023-0112994, filed in the Korean Intellectual Property Office on Aug. 28, 2023, the entire contents of which are incorporated herein by reference.

### BACKGROUND

### Technical Field

The present disclosure relates to a molded product manufactured from a thermoplastic resin composition.

### Background

An engineering plastic is used to replace a metal in a field such as a machine component and a structural material. Such engineering plastic is used for a purpose of weight reduction or the like in various fields such as interior/exterior components of a vehicle. Among the engineering plastics, polycarbonate, which is prepared by condensation polymerization or the like of an aromatic diol (e.g., bisphenol-A) and a carbonate precursor (e.g., phosgene), has high transparency and impact resistance together with excellent mechanical and thermal properties, and thus, is used as the engineering plastic in various fields (e.g., used in a lamp cover or the like).

On the other hand, the polycarbonate lacks chemical resistance, scratch resistance, and weather resistance (especially, UV stability). In the past, attempts were made to reduce such shortcomings via an additional process such as surface treatment and coating, but recently, interest in eco-friendliness is increasing and a demand for an unpainted material is increasing because of a cost reduction issue. Therefore, it is becoming difficult to apply post-process such as the surface treatment or the coating that was previously proposed to improve physical properties of the polycarbonate.

A method of using silicone and/or montan-based wax has been proposed to improve the scratch resistance of the polycarbonate. However, because the silicone has a low refractive index, optical properties deteriorate when the silicone is used on the polycarbonate. Further, the montan-based wax is easily decomposed because of low molecular weight, or has little contribution to improving the scratch resistance.

In addition, a method of using a radical scavenger (e.g., an amine-based radical scavenger) and/or a UV absorber to improve the UV stability of the polycarbonate has been proposed, but the radical scavenger decomposes the polycarbonate and the UV absorber decomposes at a processing temperature of the polycarbonate.

### SUMMARY

The present disclosure has been made to solve the above-mentioned problems occurring in the pre-existing technologies while advantages achieved by the pre-existing technologies are maintained intact.

An exemplary embodiment of the present disclosure provides a molded product that may have excellent scratch resistance and excellent weather resistance (especially, UV stability) while having excellent properties derived from polycarbonate.

The technical problems to be solved by the present disclosure are not limited to the aforementioned problems, and any other technical problems not mentioned herein will be clearly understood from the following description by those skilled in the art to which the present disclosure pertains.

According to an exemplary embodiment of the present disclosure, provided is a molded product manufactured from a thermoplastic resin composition comprising a polycarbonate-based polymer, a polysiloxane-polycarbonate copolymer, a polysiloxane-polyester copolymer, and a benzotriazole-based UV stabilizer having a molecular weight equal to or greater than about 1,800.

The polycarbonate-based polymer may be a copolymer containing two or more types of repeating units, a blend of polycarbonate polymers with different repeating units, or a combination thereof.

The polycarbonate-based polymer may have a weight-average molecular weight in a range of about 10,000 to about 50,000 g/mol.

The polycarbonate-based polymer may comprise two or more types of polycarbonate-based polymers with different weight-average molecular weights.

The polysiloxane-polycarbonate copolymer may have a weight-average molecular weight in a range of about 15,000 to about 40,000 g/mol.

A molar ratio of a polysiloxane repeating unit and a polycarbonate repeating unit in the polysiloxane-polycarbonate copolymer may be in a range of about 0.5:99.5 to about 5:95.

The polysiloxane-polyester copolymer may be represented by Chemical Formula 1 below:

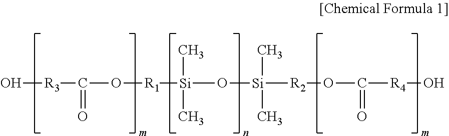

wherein each of R₁, R₂, R₃, and R₄is independently an alkylene group having 1 to 5 carbon atoms, and m and n may be integers equal to or greater than 1. An integer ratio of the m and the n in the Chemical Formula 1 may be in a range of about 1:2 to about 2:1. The R1 and the R2 in the Chemical Formula 1 are —(CH2)3-, the R3 and the R4 are —(CH2)5-, and the m and the n may be the integers equal to or greater than 1 satisfying m:n=is about 18:30.

The benzotriazole-based UV stabilizer may have a molecular weight equal to or smaller than about 3,000.

The molded product may not comprise a benzotriazole-based UV stabilizer having a molecular weight equal to or less than about 500.

The molded product may not comprise a wax.

The wax may be silicone and/or montan-based wax.

The molded product may not comprise a radical scavenger. The molded product may not comprise a UV absorber.

The thermoplastic resin composition may comprise about 70 to about 95 parts by weight of the polycarbonate-based polymer.

The thermoplastic resin composition may comprise about 70 to about 95 parts by weight of the polycarbonate-based polymer, about 5 to about 30 parts by weight of the polysiloxane-polycarbonate copolymer, about 0.3 to about 1 parts by weight of the polysiloxane-polyester copolymer, and about 2 to about 5 parts by weight of the benzotriazole-based UV stabilizer.

In some embodiments, a vehicle comprising the molded product is provided.

In some embodiments, a vehicle roof rack comprising or attached to the molded product is provided. The roof rack may comprise a lamp adjacent to the molded product such that light from the lamp emits through the molded product.

As discussed, the method and system suitably include use of a controller or processer.

### BRIEF DESCRIPTION OF THE DRAWINGS

The above and other objects, features and advantages of the present disclosure will be more apparent from the following detailed description taken in conjunction with the accompanying drawings:

FIG. 1 is a photograph of a molded product manufactured from a thermoplastic resin composition of Present Example 1.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

“Based” herein means that the element or the constituent is the main component of the composition and preferably accounts for at least 50% by weight of the composition.

Unless specifically stated herein, “copolymerization” means block copolymerization, random copolymerization, or graft copolymerization, and “copolymer” means block copolymer, random copolymer, or graft copolymer.

Unless specifically stated herein, a weight-average molecular weight is measured using Agilent Technologies' 1200 series gel permeation chromatography after dissolving a powder sample in an appropriate solvent.

The present disclosure provides a molded product manufactured from a thermoplastic resin composition containing (A) a polycarbonate-based polymer; (B) a polysiloxane-polycarbonate copolymer; (C) a polysiloxane-polyester copolymer, and (D) a benzotriazole-based UV stabilizer with a molecular weight equal to or greater than 1,800.

### Thermoplastic Resin Composition

### (A) Polycarbonate-Based Polymer

In one embodiment of the present disclosure, the thermoplastic resin composition may contain the polycarbonate-based polymer. The polycarbonate-based polymer is polyester with a carbonate bond and a type thereof is not particularly limited. Any available polycarbonate known in the art may be used for the polycarbonate-based polymer.

In one embodiment of the present disclosure, the polycarbonate-based polymer may refer to a homopolymer composed of a polycarbonate repeating unit, a copolymer containing the polycarbonate repeating unit, and a blend containing the homopolymer and/or the copolymer. However, herein, the polycarbonate-based polymer refers to a polymer that does not correspond to (B) the polysiloxane-polycarbonate copolymer, which will be described later.

The polycarbonate-based polymer may contain a repeating unit obtained from at least one selected from a group consisting of diphenols, phosgene, halogen acid ester, and carbonate ester.

Specific examples of the diphenols may include hydroquinone, resorcinol, 4,4′-dihydroxydiphenyl, 2,2-bis(4-hydroxyphenyl)propane (also known as ‘bisphenol-A’), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3-methyl-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like. Among the above examples of the diphenols, the 2,2-bis(4-hydroxyphenyl)propane, the 2,2-bis(3,5-dichloro-4-hydroxyphenyl)propane, the 2,2-bis(3,5-dimethyl-4-hydroxyphenyl)propane, or the 1,1-bis(4-hydroxyphenyl)cyclohexane may be used. More preferably, the 2,2-bis (4-hydroxyphenyl)propane may be used.

A linear polycarbonate-based polymer, a branched polycarbonate-based polymer, a polyester carbonate copolymer, or the like may be used as the polycarbonate-based polymer.

Specific examples of the linear polycarbonate-based polymer may include bisphenol-A-based polycarbonate. Specific examples of the branched polycarbonate-based polymer may include polymers prepared by reacting a polyfunctional aromatic compound such as trimellitic anhydride and trimellitic acid with the diphenols and carbonate. The polyester carbonate copolymer may be prepared by reacting difunctional carboxylic acid with the diphenols and the carbonate, and the carbonate used herein may be diaryl carbonate such as diphenyl carbonate or ethylene carbonate.

In one embodiment of the present disclosure, the polycarbonate-based polymer may be a polycarbonate copolymer containing two or more types of repeating units, a blend of polycarbonate polymers with different repeating units, or a combination thereof. Herein, the blend of the polycarbonate polymers with the different repeating units may be a mixture of homopolymers and/or copolymers with different repeating units.

In one embodiment of the present disclosure, the polycarbonate-based polymer may have a weight-average molecular weight in a range of 10,000 to 50,000 g/mol, 14,000 to 40,000 g/mol, or 18,000 to 30,000 g/mol. When the weight-average molecular weight of the polycarbonate-based polymer satisfies the above-mentioned ranges, the thermoplastic resin composition may have excellent fluidity, and impact resistance of the molded product manufactured from the thermoplastic resin composition may be improved.

In one embodiment of the present disclosure, the polycarbonate-based polymer may contain two or more types of polycarbonate-based polymers with different weight-average molecular weights. In this case, the thermoplastic resin composition may have the excellent fluidity, and weather resistance of the molded product manufactured from the thermoplastic resin composition may be improved.

A content of the polycarbonate-based polymer may be in a range of 70 to 95 parts by weight, 75 to 93 parts by weight, or 80 to 91 parts by weight with respect to 5 to 30 parts by weight of a polysiloxane-polycarbonate polymer. When the content of the polycarbonate-based polymer satisfies the above-mentioned ranges, moldability of the thermoplastic resin composition may be improved, and the impact resistance of the molded product manufactured from the thermoplastic resin composition may be improved.

### (B) Polysiloxane-Polycarbonate Copolymer

In one embodiment of the present disclosure, the thermoplastic resin composition may contain the polysiloxane-polycarbonate copolymer. The polysiloxane-polycarbonate copolymer may have improved impact strength (e.g., low-temperature impact strength, surface impact strength, and the like) and excellent chemical resistance while maintaining excellent mechanical properties derived from the polycarbonate. The polysiloxane-polycarbonate copolymer is not particularly limited in type. A siloxane compound and a carbonate compound available and known in the art may be copolymerized and used as the polysiloxane-polycarbonate copolymer or a commercially available material may be used as the polysiloxane-polycarbonate copolymer.

The polysiloxane-polycarbonate copolymer may be prepared by polymerizing the diphenols, at least one selected from the group consisting of the phosgene, the halogen acid ester, and the carbonate ester, and a siloxane-based monomer. Herein, a detailed description of the diphenols is the same as the description above.

The siloxane monomer may be at least one selected from a group consisting of hexamethylcyclotrisiloxane, octamethylcyclotetrasiloxane, decamethylcycloheptasiloxane, dodecamethylcycloheptasiloxane, trimethyltriphenylcyclotrisiloxane, tetramethyltetraphenylcyclotetrasiloxane, and octaphenylcyclotetrasiloxane.

In one embodiment of the present disclosure, a weight-average molecular weight of the polysiloxane-polycarbonate copolymer may be in a range of 15,000 to 40,000 g/mol, 20,000 to 35,000 g/mol, or 23,000 to 30,000 g/mol. When the weight-average molecular weight of the polysiloxane-polycarbonate copolymer satisfies the above-mentioned ranges, processability and the moldability of the thermoplastic resin composition may be improved, and the impact resistance and chemical resistance of the molded product manufactured from the thermoplastic resin composition may be excellent.

In one embodiment of the present disclosure, a molar ratio of a polysiloxane repeating unit and a polycarbonate repeating unit in the polysiloxane-polycarbonate copolymer may be in a range of 0.5:99.5 to 5:95, 0.8:99.2 to 4:96, or 1:99 to 3:97. When the molar ratio satisfies the above-mentioned ranges, the impact resistance of the molded product manufactured from the thermoplastic resin composition may be excellent.

A content of the polysiloxane-polycarbonate copolymer may be in a range of 5 to 30 parts by weight, 7 to 25 parts by weight, or 9 to 23 parts by weight with respect to 70 to 95 parts by weight of the polycarbonate-based polymer. When the content of the polysiloxane-polycarbonate copolymer satisfies the above-mentioned ranges, the impact resistance, transmittance, and the weather resistance of the molded product manufactured from the thermoplastic resin composition may be improved.

### (C) Polysiloxane-Polyester Copolymer

In one embodiment of the present disclosure, the thermoplastic resin composition may contain the polysiloxane-polyester copolymer. The polysiloxane-polyester copolymer may improve scratch resistance of the molded product manufactured from the thermoplastic resin composition. The polysiloxane-polyester copolymer is not particularly limited in type. The siloxane compound and an ester compound available and known in the art may be copolymerized and used as the polysiloxane-polyester copolymer or a commercially available material may be used as the polysiloxane-polyester copolymer.

In one embodiment of the present disclosure, the polysiloxane-polyester copolymer may be represented by Chemical Formula 1 below.

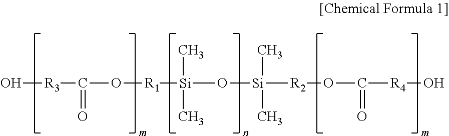

(In Chemical Formula 1, each of R₁, R₂, R₃, and R₄ is independently an alkylene group having 1 to 5 carbon atoms, and m and n are integers equal to or greater than 1.)

In one embodiment of the present disclosure, an integer ratio of the m and the n in Chemical Formula 1 may be within a range of 1:2 to 2:1 or 6:10 to 10:6. When the integer ratio of the m and the n satisfies the above-mentioned ranges, the molded product manufactured from the thermoplastic resin composition may have excellent transparency and scratch resistance.

In one embodiment of the present disclosure, the R₁ and the R₂ in Chemical Formula 1 above may be —(CH₂)₃, the R₃ and the R₄ may be —(CH₂)₅, and the m and the n may be the integers equal to or greater than 1 that satisfy m:n=18:30.

A content of the polysiloxane-polyester copolymer may be in a range of 0.3 to 1 part by weight or 0.4 to 1.3 parts by weight with respect to 70 to 95 parts by weight of the polycarbonate-based polymer. When the content of the polysiloxane-polyester copolymer satisfies the above-mentioned ranges, the scratch resistance, the impact resistance, the transmittance, and the weather resistance of the molded product manufactured from the thermoplastic resin composition may be improved.

### (D) Benzotriazole-Based UV Stabilizer

In one embodiment of the present disclosure, the thermoplastic resin composition may contain the benzotriazole-based UV stabilizer. The benzotriazole-based UV stabilizer may improve the weather resistance and thermal stability of the molded products manufactured from the thermoplastic resin composition. The benzotriazole-based UV stabilizer is not particularly limited in type as long as a molecular weight range to be described later is satisfied. A benzotriazole-based compound available and known in the art may be modified and used as the benzotriazole-based UV stabilizer or a commercially available material may be used as the benzotriazole-based UV stabilizer.

In one embodiment of the present disclosure, the benzotriazole-based UV stabilizer may have a molecular weight in a range of 1,800 to 3,000 or 1,900 to 2,500. When the molecular weight of the benzotriazole-based UV stabilizer satisfies the above-mentioned ranges, the thermoplastic resin composition may be excellent in thermal stability, and thus, may be lowered in volatility, and the weather resistance of the molded product manufactured from the thermoplastic resin composition may be improved.

A content of the benzotriazole-based UV stabilizer may be in a range of 2 to 5 parts by weight or 2.5 to 4 parts by weight with respect to 70 to 95 parts by weight of the polycarbonate-based polymer. When the content of the benzotriazole-based UV stabilizer satisfies the above-mentioned ranges, the impact resistance and the weather resistance of the molded product manufactured from the thermoplastic resin composition may be excellent.

### Molded Product

The molded product of the present disclosure is manufactured by molding the thermoplastic resin composition described above. The thermoplastic resin composition may be prepared in a pellet form, and the prepared pellet may be manufactured into various molded products via various molding methods such as injection molding, extrusion molding, vacuum molding, and casting molding. Herein, the method for molding the thermoplastic resin composition is not particularly limited, and various known molding methods may be applied.

The molded product of the present disclosure may have the excellent physical properties (e.g., the impact resistance, the scratch resistance, the transparency, and the weather resistance) derived from the polycarbonate-based polymer, the polysiloxane-polycarbonate copolymer, the polysiloxane-polyester copolymer, and the benzotriazole-based UV stabilizer contained in the thermoplastic resin composition described above. In one example, the benzotriazole-based UV stabilizer may have the molecular weight equal to or greater than 1,800. In this case, the molded product manufactured from the thermoplastic resin composition may have the excellent weather resistance (particularly, the UV stability).

### (A) PRESENT EXAMPLES

Hereinafter, the present disclosure will be described in more detail via Present Examples. However, such Present Examples are only intended to help understand the present disclosure, and the scope of the present disclosure is not limited to such Present Examples in any way.

### Present Examples 1 to 7 and Comparative Examples 1 to 4

Each of Present Examples 1 to 7, which are thermoplastic resin compositions according to the present disclosure, and Comparative Examples 1 to 4 was prepared by mixing components shown in Table 1 below with each other to form a mixture and performing the extrusion molding on the mixture to be formed in the pellet form. Next, the prepared pellet was dried and then injection-molded to manufacture a molded product. The components used herein are shown in Table 2.

TABLE 1

| | Component | Component | Component | Component | Component | Component | Component |
|---|---|---|---|---|---|---|---|
| | (a-1) | (a-2) | (b) | (c) | (d-1) | (d-2) | (e) |
| Present | 75 | 15 | 10 | 0.5 | 3 | 0 | 0 |
| Example 1 | | | | | | | |
| Present | 75 | 5 | 20 | 0.5 | 3 | 0 | 0 |
| Example 2 | | | | | | | |
| Present | 45 | 45 | 10 | 0.5 | 3 | 0 | 0 |
| Example 3 | | | | | | | |
| Present | 75 | 15 | 10 | 0.5 | 1 | 0 | 0 |
| Example 4 | | | | | | | |
| Present | 70 | 0 | 30 | 0.5 | 3 | 0 | 0 |
| Example 5 | | | | | | | |
| Present | 75 | 15 | 10 | 1.5 | 3 | 0 | 0 |
| Example 6 | | | | | | | |
| Present | 75 | 15 | 10 | 0.5 | 5 | 0 | 0 |
| Example 7 | | | | | | | |
| Comparative | 75 | 25 | 0 | 0.5 | 3 | 0 | 0 |
| Example 1 | | | | | | | |
| Comparative | 75 | 15 | 10 | 0 | 3 | 0 | 0 |
| Example 2 | | | | | | | |
| Comparative | 75 | 15 | 10 | 0 | 3 | 0 | 0.5 |
| Example 3 | | | | | | | |
| Comparative | 75 | 15 | 10 | 0.5 | 0 | 3 | 0 |
| Example 4 | | | | | | | |

TABLE 2

| Component | Detailed description |
|---|---|
| Component | Bisphenol-A-type linear polycarbonate resin with weight-average molecular |
| (a-1) | weight of approximately 20,000 g/mol |
| Component | Bisphenol-A-type linear polycarbonate resin with weight-average molecular |
| (a-2) | weight of approximately 25,000 g/mol |
| Component | Linear polysiloxane-polycarbonate resin with weight-average molecular weight |
| (b) | of approximately 24,000 g/mol and ratio of polysiloxane repeating unit to |
| | polycarbonate repeating unit in range of 1:99 to 2:98. |
| Component | Siloxane-polyester copolymer in Chemical Formula 2 below |
| (c) | |
| | 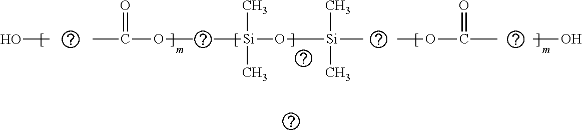 |
| Component | Multifunctional benzotriazole-based UV stabilizer with molecular weight of |
| (d-1) | 2,500 |
| Component | Bifunctional benzotriazole-based UV stabilizer with molecular weight of 350 |
| (d-2) | |
| Component | Ethylene bis stearamide-based wax |
| (e) | |

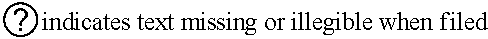

### Experimental Example

### Measurement Method

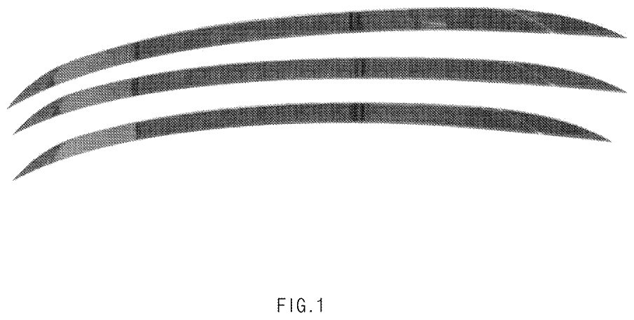

Impact resistance: Notched Izod impact strength was measured at a room temperature based on an evaluation method specified in ISO 180 1A.
   ⊚ (excellent): Impact strength equal to or greater than 12 kJ/m²
   Δ (normal): Impact strength equal to or greater than 10 KJ/m² and smaller than 12 kJ/m²
   X (insufficient): Impact strength smaller than 10 KJ/m²
Scratch resistance: Using Ericshen evaluation equipment, scratches were made in a grid pattern under conditions of 20 scratches with a load of 10 N and a scratching speed of 1,000 mm/min, and whether the scratches exist was determined with the naked eye.
   None-existence: No scratches found with the naked eye
   Existence: Scratches found with the naked eye
Transparency: Transmittance of sample with thickness of 3 mm was measured at a room temperature based on a method of ASTM D1003.
   ⊚ (excellent): Transmittance equal to or greater than 80%
   Δ (normal): Transmittance equal to or greater than 50% and smaller than 80%
   X (insufficient): Transmittance smaller than 50%
Weather resistance: Molded product (1200 mm×25 mm×3 mm) as shown in FIG. 1 was cut and irradiated with 2,500 kJ under SAE J 2527 conditions. Then, a color change (ΔE) was measured using a BYK solid spectrophotometer with a D65 light source and BYK 45/0 Geometry.
   ⊚ (excellent): Color change (ΔE) smaller than 3
   Δ (normal): Color change (ΔE) equal to or greater than 3 and smaller than 6
   X (insufficient): Color change (ΔE) equal to or greater than 6

### Measurement Results

In one example, evaluation result values measured using the above test methods are shown in Table 3 below.

TABLE 3

| | Impact | Scratch | | Weather |
|---|---|---|---|---|
| | resistance | resistance | Transparency | resistance |
| Present | ⊚ | None-existence | ⊚ | ⊚ |
| Example 1 | | | | |
| Present | ⊚ | None-existence | ⊚ | ⊚ |
| Example 2 | | | | |
| Present | ⊚ | None-existence | ⊚ | ⊚ |
| Example 3 | | | | |
| Present | ⊚ | None-existence | ⊚ | Δ |
| Example 4 | | | | |
| Present | ⊚ | None-existence | ⊚ | Δ |
| Example 5 | | | | |
| Present | ⊚ | None-existence | ⊚ | X |
| Example 6 | | | | |
| Present | X | None-existence | ⊚ | ⊚ |
| Example 7 | | | | |
| Comparative | X | None-existence | X | X |
| Example 1 | | | | |
| Comparative | Δ | Existence | ⊚ | ⊚ |
| Example 2 | | | | |
| Comparative | Δ | Existence | ⊚ | ⊚ |
| Example 3 | | | | |
| Comparative | Δ | None-existence | ⊚ | X |
| Example 4 | | | | |

According to Table 3, the compounds in Present Examples 1 to 3 were all excellent in the impact resistance, the scratch resistance, the transparency, and the weather resistance. Present Example 4 had slightly insufficient weather resistance because of containing the slightly smaller amount of the benzotriazole-based UV stabilizer. Present Example 5 had slightly insufficient weather resistance because of the use of the one type of polycarbonate-based polymer. Present Example 6 had slightly insufficient transparency and insufficient weather resistance because of excessive use of the polysiloxane-polyester. In addition, Present Example 7 had slightly insufficient impact resistance because of excessive use of the benzotriazole-based UV stabilizer.

On the other hand, Comparative Example 1 did not contain the polysiloxane-polycarbonate copolymer and was inferior in the impact resistance, the transparency, and the weather resistance. Comparative Example 2 did not contain the polysiloxane-polyester copolymer, and thus, had insufficient impact resistance and insufficient scratch resistance. Comparative Example 3 did not contain the polysiloxane-polyester copolymer, but contained the wax, and thus, had insufficient impact resistance and insufficient scratch resistance. Comparative Example 4 used the benzotriazole-based UV stabilizer with a molecular weight smaller than 1,800, and thus, had insufficient impact resistance and insufficient weather resistance.

The molded product manufactured from the thermoplastic resin composition of the present disclosure may have the excellent impact resistance, scratch resistance, and weather resistance (especially, UV stability), may exhibit the high transparency, and may be used in the interior/exterior components of the vehicle, electrical and electronic components, and the like where such characteristics are required.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A molded product manufactured from a thermoplastic resin composition comprising:
a polycarbonate-based polymer,
a polysiloxane-polycarbonate copolymer;
a polysiloxane-polyester copolymer; and
a benzotriazole-based UV stabilizer having a molecular weight equal to or greater than about 1,800.

2. The molded product of claim 1, wherein the polycarbonate-based polymer is a copolymer containing two or more types of repeating units, a blend of polycarbonate polymers with different repeating units, or a combination thereof.

3. The molded product of claim 1, wherein the polycarbonate-based polymer has a weight-average molecular weight in a range of about 10,000 to about 50,000 g/mol.

4. The molded product of claim 1, wherein the polycarbonate-based polymer comprises two or more types of polycarbonate-based polymers with different weight-average molecular weights.

5. The molded product of claim 1, wherein the polysiloxane-polycarbonate copolymer has a weight-average molecular weight in a range of about 15,000 to about 40,000 g/mol.

6. The molded product of claim 1, wherein a molar ratio of a polysiloxane repeating unit and a polycarbonate repeating unit in the polysiloxane-polycarbonate copolymer is in a range of about 0.5:99.5 to about 5:95.

7. The molded product of claim 1, wherein the polysiloxane-polyester copolymer is represented by Chemical Formula 1 below: 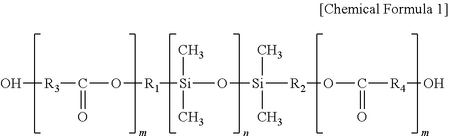
wherein each of R₁, R₂, R₃, and R₄ is independently an alkylene group having 1 to 5 carbon atoms, and m and n are integers equal to or greater than 1.

8. The molded product of claim 7, wherein an integer ratio of the m and the n in the Chemical Formula 1 is in a range of about 1:2 to about 2:1.

9. The molded product of claim 7, wherein the R₁ and the R₂ in the Chemical Formula 1 are —(CH₂)₃—, the R₃ and the R₄ are —(CH₂)₅—, and the m and the n are the integers equal to or greater than 1 satisfying m:n is about 18:30.

10. The molded product of claim 1, wherein the benzotriazole-based UV stabilizer has a molecular weight equal to or smaller than about 3,000.

11. The molded product of claim 1, wherein the molded product does not comprise a benzotriazole-based UV stabilizer having a molecular weight equal to or less than about 500.

12. The molded product of claim 1, wherein the molded product does not comprise a wax.

13. The molded product of claim 12, wherein the wax is silicone and/or montan-based wax.

14. The molded product of claim 1, wherein the molded product does not comprise a radical scavenger.

15. The molded product of claim 1, wherein the molded product does not comprise a UV absorber.

16. The molded product of claim 1, wherein the thermoplastic resin composition comprises about 70 to about 95 parts by weight of the polycarbonate-based polymer.

17. The molded product of claim 1, wherein the thermoplastic resin composition comprises about 70 to about 95 parts by weight of the polycarbonate-based polymer, about 5 to about 30 parts by weight of the polysiloxane-polycarbonate copolymer, about 0.3 to about 1 parts by weight of the polysiloxane-polyester copolymer, and about 2 to about 5 parts by weight of the benzotriazole-based UV stabilizer.

18. A vehicle comprising the molded product of claim 1.

19. A vehicle roof rack comprising or attached to the molded product of claim 1.

20. The vehicle roof rack of claim 19, further comprising a lamp adjacent to the molded product such that light from the lamp emits through the molded product.
